(19) United States
(12) Patent Application Publication
(10) Pub. No.: US 2018/0178082 A1
(43) Pub. Date: Jun. 28, 2018

(54) GOLF BALL

(71) Applicant: Dunlop Sports Co. Ltd., Kobe-shi (JP)

(72) Inventors: Kai HAYASHI, Kobe-shi (JP); Masatoshi YOKOTA, Kobe-shi (JP); Toshiyuki TARAO, Kobe-shi (JP)

(73) Assignee: Dunlop Sports Co. Ltd., Kobe-shi (JP)

(21) Appl. No.: 15/854,238

(22) Filed: Dec. 26, 2017

(30) Foreign Application Priority Data
Dec. 27, 2016 (JP) 2016-253566

(51) Int. Cl. A63B 37/00; C08C 19/28

(52) U.S. Cl. CPC A63B 37/0074; A63B 37/0051; A63B 37/0027; C08C 19/28

(57) ABSTRACT

An object of the present invention is to provide a golf ball excellent in resilience performance. The present invention provides a golf ball comprising a spherical core and at least one cover layer covering the spherical core, wherein the spherical core is formed from a rubber composition containing (a) a base rubber, (b) a compound represented by a formula (1) as a co-crosslinking agent and (c) a crosslinking initiator.

(R¹OCO)M(COOR²)ₘ (1)

[In the formula (1), M represents a metal atom, R¹ and R² represent an alkenyl group having 2 to 30 carbon atoms, an alkynyl group having 2 to 30 carbon atoms, an alkyl group having 1 to 30 carbon atoms or an aryl group having 6 to 30 carbon atoms, and m represents 1 or 2.]

### FIELD OF THE INVENTION

The present invention relates to a golf ball excellent in resilience performance, and specifically, relates to a technology for improving a core of a golf ball.

### DESCRIPTION OF THE RELATED ART

Generally, a solid rubber core of a golf ball is prepared by heat pressing a rubber composition containing polybutadiene rubber as a base rubber, an unsaturated carboxylic acid metal salt as a co-crosslinking agent, dicumyl peroxide as a crosslinking initiator, and the like. In this composition, the unsaturated carboxylic acid metal salt is grafted to the main chain of the polybutadiene by the crosslinking initiator such as dicumyl peroxide, and functions as a co-crosslinking agent.

Examples of the golf ball using such the unsaturated carboxylic acid metal salt include Japanese Patent Publications No. S59-141961 A and No. S60-92781 A. These Japanese Patent Publications disclose a golf ball comprising a core formed from a rubber composition containing zinc acrylate as a co-crosslinking agent, wherein a surface of the zinc acrylate is coated with one or at least two higher fatty acids or higher fatty acid metal salts (refer to claim 1 in Japanese Patent Publication No. S59-141961 A and claim 1 in Japanese Patent Publication No. S60-92781 A).

### SUMMARY OF THE INVENTION

In a conventional golf ball, zinc acrylate is widely used as a co-crosslinking agent. However, further improvement in the resilience of a golf ball is desired. The present invention has been made in view of the above mentioned circumstances, and an object of the present invention is to provide a golf ball excellent in the resilience performance.

The present invention that has solved the above problems provides a golf ball comprising a spherical core and at least one cover layer covering the spherical core, wherein the spherical core is formed from a rubber composition containing (a) a base rubber, (b) a co-crosslinking agent and (c) a crosslinking initiator, and (b) the co-crosslinking agent contains a compound represented by a formula (1). If the compound represented by the formula (1) is blended as the co-crosslinking agent, the resilience performance of the golf ball can be enhanced while maintaining the softness of the golf ball. Thus, the golf ball according to the present invention is excellent in the resilience performance.

(R¹OCO)M(COOR²)ₘ (1)

[In the formula (1), M represents a metal atom, and m represents 1 or 2. When m is 1, R¹ and R² are different from each other and represent an alkenyl group having 2 to 30 carbon atoms or an alkynyl group having 2 to 30 carbon atoms. When m is 2, R¹ represents an alkenyl group having 2 to 30 carbon atoms, an alkynyl group having 2 to 30 carbon atoms, an alkyl group having 1 to 30 carbon atoms or an aryl group having 6 to 30 carbon atoms, and two of R² are identical to or different from each other and represent an alkenyl group having 2 to 30 carbon atoms or an alkynyl group having 2 to 30 carbon atoms. When m is 2, a compound in which R¹ and two of R² are all identical to each other is excluded.].

In the compound represented by the formula (1), the metal atom (M) is preferably at least one metal atom selected from the group consisting of zinc, magnesium, calcium and aluminum. In the compound represented by the formula (1), R² is preferably an alkenyl group having 2 to 30 carbon atoms and a carbon-carbon double bond at a carbon atom bonding to the carbonyl group of the compound represented by the formula (1). In the compound represented by the formula (1), R¹ is preferably an alkenyl group having 2 to 30 carbon atoms and a carbon-carbon double bond not at a carbon atom bonding to the carbonyl group of the compound represented by the formula (1). In the compound represented by the formula (1), R¹ preferably has more carbon atoms than R².

According to the present invention, a golf ball excellent in the resilience performance is obtained.

### BRIEF DESCRIPTION OF THE DRAWINGS

FIG. 1 is a partially cutaway cross-sectional view showing a golf ball according to an embodiment of the present invention; and

FIG. 2 is a figure showing a relationship between the compression deformation amount and the coefficient of restitution.

### DESCRIPTION OF THE PREFERRED EMBODIMENT

The present invention that has solved the above problems provides a golf ball comprising a spherical core and at least one cover layer covering the spherical core, wherein the spherical core is formed from a rubber composition containing (a) a base rubber, (b) a co-crosslinking agent and (c) a crosslinking initiator, and (b) the co-crosslinking agent contains a compound represented by a formula (1) which will be described later.

When molding the spherical core, (b) the co-crosslinking agent crosslinks a rubber molecule by forming a graft polymer by a graft reaction to (a) the base rubber in the rubber composition. In addition, the compound represented by the formula (1) contained in (b) the co-crosslinking agent is capable of forming an ion cluster, and thus the graft reaction of the component (b) constituting the ion duster to (a) the base rubber more easily proceeds. Herein, the compound represented by the formula (1) has an alkenyl group and/or an alkynyl group, which have a structure different from each other. Such the alkenyl group and/or the alkynyl group, which have a structure different from each other, have a different reactivity from each other in the graft reaction. As a result, the growth of the graft polymer is suppressed and the size between crosslinking points becomes short, and thus the obtained spherical core is considered to become highly resilient.

### [Spherical Core]

The spherical core is formed from a rubber composition containing (a) a base rubber, (b) a co-crosslinking agent and (c) a crosslinking initiator.

### ((a) Base Rubber)

As (a) the base rubber, a natural rubber and/or a synthetic rubber may be used. Examples of the base rubber include a polybutadiene rubber, a natural rubber, a polyisoprene rubber, a styrene polybutadiene rubber, and an ethylene-propylene-diene rubber (EPDM). These base rubbers may be used solely, or at least two of them may be used in combination. Among them, particularly preferred is a high-cispolybutadiene having a cis-bond which is beneficial to the resilience in an amount of 40 mass % or more, preferably 80 mass % or more, and more preferably 90 mass % or more. The amount of the high-cispolybutadiene in (a) the base rubber is preferably 50 mass % or more, more preferably 70 mass % or more.

The high-cispolybutadiene preferably contains a 1,2-vinyl bond in an amount of 2 mass % or less, more preferably 1.7 mass % or less, and even more preferably 1.5 mass % or less. If the amount of the 1,2-vinyl bond is too large, the resilience may be lowered.

The high-cispolybutadiene preferably includes one synthesized using a rare-earth element catalyst. When a neodymium catalyst, which employs a neodymium compound of a lanthanum series rare-earth element compound, is used, a polybutadiene rubber having the cis-1,4 bond in a high amount and the 1,2-vinyl bond in a low amount is obtained with excellent polymerization activity. Such polybutadiene rubber is particularly preferred.

The high-cispolybutadiene preferably has a Mooney viscosity (ML₁₊₄ (100° C.)) of 30 or more, more preferably 32 or more, and even more preferably 35 or more, and preferably has a Mooney viscosity (ML₁₊₄ (100° C.)) of 140 or less, more preferably 120 or less, even more preferably 100 or less, and most preferably 80 or less. It is noted that the Mooney viscosity (ML₁₊₄ (100° C.)) in the present invention is a value measured according to JIS K6300-1 (2013) using an L rotor under the conditions of: a preheating time of 1 minute; a rotor rotation time of 4 minutes; and a temperature of 100° C.

The high-cispolybutadiene preferably has a molecular weight distribution Mw/Mn (Mw: weight average molecular weight, Mn: number average molecular weight) of 2.0 or more, more preferably 2.2 or more, even more preferably 2.4 or more, and most preferably 2.6 or more, and preferably has a molecular weight distribution Mw/Mn of 6.0 or less, more preferably 5.0 or less, even more preferably 4.0 or less, and most preferably 3.4 or less. If the molecular weight distribution (Mw/Mn) of the high-cispolybutadiene is excessively low, the processability may deteriorate. If the molecular weight distribution (Mw/Mn) of the high-cispolybutadiene is excessively low, the workability may be lowered, and if the molecular weight distribution (Mw/Mn) of the high-cis polybutadiene is excessively high, the resilience may be lowered. It is noted that the measurement of the molecular weight distribution is conducted by gel permeation chromatography (“HLC-8120GPC” available from Tosoh Corporation) using a differential refractometer as a detector under the conditions of column: GMHHXL (available from Tosoh Corporation), column temperature: 40° C. and mobile phase: tetrahydrofuran, and calculated by converting based on polystyrene standard.

### ((b) Co-Crosslinking Agent)

(b) the co-crosslinking agent contains the compound represented by the formula (1). If the compound represented by the formula (1) is contained as the co-crosslinking agent, the resilience performance can be enhanced while maintaining the softness of the core.

(R¹OCO)M(COOR²)ₘ (1)

[In the formula (1), M represents a metal atom, and m represents 1 or 2. When m is 1, R¹ and R² are different from each other and represent an alkenyl group having 2 to 30 carbon atoms or an alkynyl group having 2 to 30 carbon atoms. When m is 2, R¹ represents an alkenyl group having 2 to 30 carbon atoms, an alkynyl group having 2 to 30 carbon atoms, an alkyl group having 1 to 30 carbon atoms or an aryl group having 6 to 30 carbon atoms, and two of R² are identical to or different from each other and represent an alkenyl group having 2 to 30 carbon atoms or an alkynyl group having 2 to 30 carbon atoms. When m is 2, a compound in which R¹ and two of R² are all identical to each other is excluded.].

Examples of the metal atom (M) include an alkaline earth metal such as calcium, strontium and barium; a transition metal such as scandium, titanium, vanadium, chromium, manganese, iron, cobalt, nickel, copper, yttrium, zirconium, niobium, molybdenum, technetium, ruthenium, rhodium, palladium, silver, hafnium, tantalum, tungsten, rhenium, osmium, iridium, platinum and gold; and a base metal such as beryllium, magnesium, aluminum, zinc, gallium, cadmium, indium, tin, thallium, lead, bismuth and polonium. These metal atoms may be used solely, or at least two of them may be used. Among them, as the metal atom, the metal atom capable of forming a divalent or trivalent metal ion is preferable, and at least one member selected from the group consisting of beryllium, magnesium, calcium, zinc, barium, cadmium, lead and aluminum is more preferable.

The alkenyl group having 2 to 30 carbon atoms may have a linear structure or a branched structure, and the linear structure is preferable. The alkenyl group preferably has one carbon-carbon double bond. Preferable examples of the alkenyl group include an alkenyl group having a carbon-carbon double bond at a carbon atom bonding to the carbonyl group in the formula (1); and an alkenyl group having no carbon-carbon double bond at a carbon atom bonding to the carbonyl group in the formula (1).

Examples of the alkenyl group having a carbon-carbon double bond at a carbon atom bonding to the carbonyl group include ethenyl group (vinyl group), 1-propenyl group, isopropenyl group and 1-butenyl group. The alkenyl group preferably has 10 or less carbon atoms, more preferably 8 or less carbon atoms, even more preferably 6 or less carbon atoms, and most preferably 4 or less carbon atoms.

Examples of the alkenyl group having no carbon-carbon double bond at a carbon atom bonding to the carbonyl group include 2-propenyl group, 3-butenyl group, 4-pentenyl group, 5-hexenyl group, 6-heptenyl group, 7-octenyl group, 8-nonenyl group, 9-decenyl group, 10-undecenyl group, 11-dodecenyl group, 8-tridecenyl group, 12-tridecenyl group, 13-tetradecenyl group, 8-pentadecenyl group, 14-pentadecenyl group, 15-hexadecenyl group, 8-heptadecenyl group, 10-heptadecenyl group, 16-heptadecenyl group, and 17-octadecenyl group. The alkenyl group preferably has 5 or more carbon atoms, more preferably 10 or more carbon atoms, and even more preferably 15 or more carbon atoms, and preferably has 30 or less carbon atoms, more preferably 25 or less carbon atoms, and even more preferably 20 or less carbon atoms.

The alkynyl group having 2 to 30 carbon atoms may have a linear structure or a branched structure, and the linear structure is preferable. As the alkynyl group, an alkynyl group having one carbon-carbon triple bond is preferable. Preferable examples of the alkynyl group include an alkynyl group having a carbon-carbon triple bond at a carbon atom bonding to the carbonyl group in the formula (1); and an alkynyl group having no carbon-carbon triple bond at a carbon atom bonding to the carbonyl group in the formula (1).

Examples of the alkynyl group having a carbon-carbon triple bond at a carbon atom bonding to the carbonyl group include ethynyl group, 1-propynyl group and 1-butynyl group. The alkynyl group preferably has 10 or less carbon atoms, more preferably 8 or less carbon atoms, even more preferably 6 or less carbon atoms, and most preferably 4 or less carbon atoms.

Examples of the alkynyl group having no carbon-carbon triple bond at a carbon atom bonding to the carbonyl group include 2-propenyl group, 3-butynyl group, 4-pentynyl group, 5-hexynyl group, 6-heptynyl group, 7-octynyl group, 8-nonynyl group, 9-decynyl group, 10-undecynyl group, 11-dodecynyl group, 8-tridecynyl group, 12-tridecynyl group, 13-tetradecynyl group, 8-pentadecynyl group, 14-pentadecynyl group, 15-hexadecynyl group, 8-heptadecynyl group, 10-heptadecynyl group, 16-heptadecynyl group, and 17-octadecynyl group. The alkynyl group preferably has 5 or more carbon atoms, more preferably 10 or more carbon atoms, and even more preferably 15 or more carbon atoms, and preferably has 30 or less carbon atoms, more preferably 25 or less carbon atoms, and even more preferably 20 or less carbon atoms.

The alkyl group having 1 to 30 carbon atoms may have a linear structure, a branched structure or a cyclic structure, and the linear structure is preferable. Examples of the alkyl group include methyl group, ethyl group, propyl group, butyl group, pentyl group, hexyl group, heptyl group, octyl group, nonyl group, decyl group, undecyl group, dodecyl group, tridecyl group, tetradecyl group, pentadecyl group, hexadecyl group, heptadecyl group, and octadecyl group. The alkyl group preferably has 2 or more carbon atoms, more preferably 10 or more carbon atoms, and even more preferably 15 or more carbon atoms, and preferably has 30 or less carbon atoms, more preferably 25 or less carbon atoms, and even more preferably 20 or less carbon atoms.

Examples of the aryl group having 6 to 30 carbon atoms include phenyl group, naphthyl group, anthryl group, biphenyl group, phenanthryl group, and fluorenyl group.

In the formula (1), when m is 1, it is preferred that R² is the alkenyl group having 2 to 30 carbon atoms and a carbon-carbon double bond at a carbon atom bonding to the carbonyl group or the alkynyl group having 2 to 30 carbon atoms and a carbon-carbon triple bond at a carbon atom bonding to the carbonyl group, and R¹ is the alkenyl group having 2 to 30 carbon atoms and no carbon-carbon double bond at a carbon atom bonding to the carbonyl group or the alkynyl group having 2 to 30 carbon atoms and no carbon-carbon triple bond at a carbon atom bonding to the carbonyl group. In addition, in this case, R¹ preferably has more carbon atoms than R².

In the formula (1), when m is 2, it is preferred that one of R² is the alkenyl group having 2 to 30 carbon atoms and a carbon-carbon double bond at a carbon atom bonding to the carbonyl group or the alkynyl group having 2 to 30 carbon atoms and a carbon-carbon triple bond at a carbon atom bonding to the carbonyl group, and the other one of R² is the alkenyl group having 2 to 30 carbon atoms and no carbon-carbon double bond at a carbon atom bonding to the carbonyl group or the alkynyl group having 2 to 30 carbon atoms and no carbon-carbon triple bond at a carbon atom bonding to the carbonyl group. In addition, in this case, the group having no carbon-carbon unsaturated bond at a carbon atom bonding to the carbonyl group preferably has more carbon atoms than the group having a carbon-carbon unsaturated bond at a carbon atom bonding to the carbonyl group.

Preferable examples of the compound represented by the formula (1) include a compound represented by the following formula (2) or a compound represented by the following formula (3).

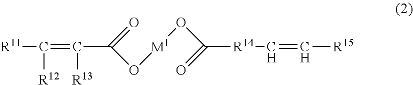

[In the formula (2), M¹ represents a metal atom, R¹¹, R¹² and R¹³ are identical to or different from each other and represent a hydrogen atom or an alkyl group having 1 to 28 carbon atoms, R¹⁴ represents an alkylene group having 1 to 28 carbon atoms, and R¹⁵ represents a hydrogen atom or an alkyl group having 1 to 27 carbon atoms.].

The metal atom (M¹) is preferably at least one member selected from the group consisting of beryllium, magnesium, calcium, zinc, barium, cadmium, lead and aluminum. R¹¹ is preferably a hydrogen atom, methyl group or ethyl group. R¹² is preferably a hydrogen atom, methyl group or ethyl group. R¹³ is preferably a hydrogen atom or methyl group. Preferable examples of the combination of R¹¹ to R¹³ include a combination in which R¹¹ to R¹³ are a hydrogen atom; and a combination in which R¹¹ and R¹² are a hydrogen atom, and R¹³ is a methyl group.

The alkylene group having 1 to 28 carbon atoms represented by the above R¹⁴ may have a branched structure or a cyclic structure, and the linear alkylene group is preferable. The alkylene group preferably has 3 or more carbon atoms, more preferably 5 or more carbon atoms, and even more preferably 7 or more carbon atoms, and preferably has 28 or less carbon atoms, more preferably 20 or less carbon atoms, and even more preferably 15 or less carbon atoms.

The alkyl group having 1 to 27 carbon atoms represented by the above R¹⁵ may have a branched structure or a cyclic structure, and the linear alkyl group is preferable. The alkyl group represented by the above R¹⁵ preferably has 3 or more carbon atoms, more preferably 5 or more carbon atoms, and even more preferably 7 or more carbon atoms, and preferably has 27 or less carbon atoms, more preferably 20 or less carbon atoms, and even more preferably 15 or less carbon atoms.

The above R¹⁴ and R¹⁵ preferably have 5 or more carbon atoms in total, more preferably 10 or more carbon atoms in total, and even more preferably 15 or more carbon atoms in total, and preferably have 28 or less carbon atoms in total, more preferably 25 or less carbon atoms in total, and even more preferably 20 or less carbon atoms in total. The ratio (R¹⁴/R¹⁵) of the carbon atoms included in R¹⁴ to the carbon atoms included in R¹⁵ is preferably 0.1 or more, more preferably 0.5 or more, and even more preferably 0.8 or more, and is preferably 10.0 or less, more preferably 5.0 or less, and even more preferably 1.3 or less.

Examples of the compound represented by the formula (2) include a compound in which R¹¹ to R¹³ are a hydrogen atom, R¹⁴ is a heptylene group, and R¹⁵ is a butyl group; a compound in which R¹¹ to R¹³ are a hydrogen atom, R¹⁴ is a heptylene group, and R¹⁵ is a hexyl group; a compound in which R¹¹ to R¹³ are a hydrogen atom, R¹⁴ is a heptylene group, and R¹⁵ is an octyl group; a compound in which R¹¹ to R¹³ are a hydrogen atom, R¹¹ is a nonylene group, and R¹⁵ is a hexyl group; a compound in which R¹¹ to R¹³ are a hydrogen atom, R¹¹ is a nonylene group, and R¹⁵ is an octyl group; a compound in which R¹¹ to R¹³ are a hydrogen atom, R¹⁴ is a undecylene group, and R¹⁵ is an octyl group; a compound in which R¹¹ to R¹³ are a hydrogen atom, R¹⁴ is a tridecylene group, and R¹⁵ is an octyl group; a compound in which R¹¹ and R¹² are a hydrogen atom, R¹³ is a methyl group, R¹⁴ is a heptylene group, and R¹⁵ is a butyl group: a compound in which R¹¹ and R¹² are a hydrogen atom, R¹³ is a methyl group, R¹⁴ is a heptylene group, and R¹⁵ is a hexyl group; a compound in which R¹¹ and R¹² are a hydrogen atom, R¹³ is a methyl group, R¹⁴ is a heptylene group, and R¹⁵ is an octyl group; a compound in which R¹¹ and R¹² are a hydrogen atom, R¹³ is a methyl group, R¹⁴ is a nonylene group, and R¹⁵ is a hexyl group; a compound in which R¹¹ and R¹² are a hydrogen atom, R¹³ is a methyl group, R¹⁴ is a nonylene group, and R¹⁵ is an octyl group; a compound in which R¹¹ and R¹² are a hydrogen atom, R¹³ is a methyl group, R¹⁴ is a undecylene group, and R¹⁵ is an octyl group; and a compound in which R¹¹ and R¹² are a hydrogen atom, R¹³ is a methyl group, R¹⁴ is a tridecylene group, and R¹⁵ is an octyl group.

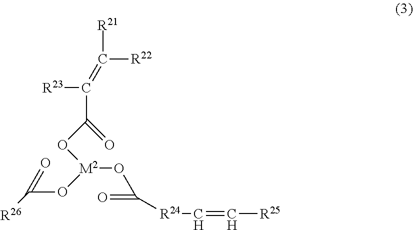

[In the formula (3), M² represents a metal atom, R²¹, R²² and R²³ are identical to or different from each other and represent a hydrogen atom or an alkyl group having 1 to 28 carbon atoms, R²⁴ represents an alkylene group having 1 to 28 carbon atoms, R²⁵ represents a hydrogen atom or an alkyl group having 1 to 27 carbon atoms, R²⁶ represents an alkenyl group having 2 to 30 carbon atoms, an alkynyl group having 2 to 30 carbon atoms, an alkyl group having 1 to 30 carbon atoms, or an aryl group having 6 to 30 carbon atoms.].

The metal atom (M²) is preferably at least one member selected from the group consisting of beryllium, magnesium, calcium, zinc, barium, cadmium, lead and aluminum. R²¹ is preferably a hydrogen atom, methyl group or ethyl group. R²² is preferably a hydrogen atom, methyl group or ethyl group. R²³ is preferably a hydrogen atom or methyl group. Preferable examples of the combination of R²¹ to R²³ include a combination in which R²¹ to R²³ are a hydrogen atom; and a combination in which R²¹ and R²² are a hydrogen atom, and R²³ is a methyl group.

The alkylene group having 1 to 28 carbon atoms represented by the above R²⁴ may have a branched structure or a cyclic structure, and the linear alkylene group is preferable. The alkylene group preferably has 3 or more carbon atoms, more preferably 5 or more carbon atoms, and even more preferably 7 or more carbon atoms, and preferably has 28 or less carbon atoms, more preferably 20 or less carbon atoms, and even more preferably 15 or less carbon atoms.

The alkyl group having 1 to 27 carbon atoms represented by the above R²⁵ may have a branched structure or a cyclic structure, and the linear alkyl group is preferable. The alkyl group represented by the above R²⁵ preferably has 3 or more carbon atoms, more preferably 5 or more carbon atoms, and even more preferably 7 or more carbon atoms, and preferably has 27 or less carbon atoms, more preferably 20 or less carbon atoms, and even more preferably 15 or less carbon atoms.

The above R²⁴ and R²⁵ preferably have 5 or more carbon atoms in total, more preferably 10 or more carbon atoms in total, and even more preferably 15 or more carbon atoms in total, and preferably have 28 or less carbon atoms in total, more preferably 25 or less carbon atoms in total, and even more preferably 20 or less carbon atoms in total. The ratio (R²⁴/R²⁵) of the carbon atoms included in R²⁴ to the carbon atoms included in R²⁵ is preferably 0.1 or more, more preferably 0.5 or more, and even more preferably 0.8 or more, and is preferably 10.0 or less, more preferably 5.0 or less, and even more preferably 1.3 or less.

Preferable examples of R²⁶ include ethenyl group, 1-propenyl group, isopropenyl group, 8-tridecenyl group, 8-pentadecenyl group, 8-heptadecenyl group, and 10-heptadecenyl group.

(b) The co-crosslinking agent may further contain another co-crosslinking agent than the compound represented by the general formula (1), unless the other co-crosslinking agent impairs the effect of the present invention. Examples of the other co-crosslinking agent include an α,β-unsaturated carboxylic acid having 3 to 8 carbon atoms and/or a metal salt thereof. The α,β-unsaturated carboxylic acid having 3 to 8 carbon atoms and/or the metal salt thereof has an action of crosslinking a rubber molecule by graft polymerization to a base rubber molecular chain. Examples of the α,β-unsaturated carboxylic acid having 3 to 8 carbon atoms include acrylic acid, methacrylic acid, fumaric acid, maleic acid, and crotonic acid.

Examples of the metal constituting the metal salt of the α,β-unsaturated carboxylic acid having 3 to 8 carbon atoms include a monovalent metal ion such as sodium, potassium and lithium; a divalent metal ion such as magnesium, calcium, zinc, barium and cadmium; a trivalent metal ion such as aluminum; and other metal ion such as tin and zirconium. The metal component may be used solely or as a mixture of at least two of them. Among them, as the metal component, the divalent metal such as magnesium, calcium, zinc, barium, cadmium or the like is preferred. This is because use of the divalent metal salt of the α,β-unsaturated carboxylic acid having 3 to 8 carbon atoms easily generates a metal crosslinking between the rubber molecules.

In the case that the other co-crosslinking is used, the amount of the compound represented by the general formula (1) in (b) the co-crosslinking agent is preferably 3 mass % or more, more preferably 5 mass % or more, and even more preferably 10 mass % or more, and is preferably 40 mass % or less, more preferably 30 mass % or less, and even more preferably 20 mass % or less. If the amount of the compound represented by the general formula (1) falls within the above range, the metal crosslinking is easily generated.

The amount of (b) the co-crosslinking agent in the rubber composition is preferably 10 parts by mass or more, more preferably 15 parts by mass or more, and even more preferably 20 parts by mass or more, and is preferably 50 parts by mass or less, more preferably 45 parts by mass or less, and even more preferably 40 parts by mass or less, with respect to 100 parts by mass of (a) the base rubber. If the amount of (b) the co-crosslinking agent is less than 10 parts by mass, the amount of (c) the crosslinking initiator which will be described later must be increased in order to obtain an appropriate hardness of the constituting member formed from the rubber composition, which tends to lower the resilience of the molded product of the crosslinked rubber. On the other hand, if the amount of (b) the co-crosslinking agent exceeds 50 parts by mass, the constituting member formed from the rubber composition tends to become too hard.

### ((c) Crosslinking Initiator)

(c) The crosslinking initiator is blended in order to crosslink (a) the base rubber component. As (c) the crosslinking initiator, an organic peroxide is preferred. Specific examples of the organic peroxide include an organic peroxide such as dicumyl peroxide, 1,1-bis(t-butylperoxy)-3,3,5-trimethylcyclohexane, 2,5-dimethyl-2,5-di(t-butylperoxy)hexane and di-t-butylperoxide. These organic peroxides may be used solely, or at least two of them may be used in combination. Among them, dicumyl peroxide is preferably used.

The amount of (c) the crosslinking initiator is preferably 0.2 part by mass or more, more preferably 0.5 part by mass or more, and is preferably 5.0 parts by mass or less, more preferably 2.5 parts by mass or less, with respect to 100 parts by mass of (a) the base rubber. If the amount of (c) the crosslinking initiator is less than 0.2 part by mass, the constituting member formed from the rubber composition becomes so soft that the resilience of the golf ball may be lowered. If the amount of (c) the crosslinking initiator exceeds 5.0 parts by mass, the amount of (b) the co-crosslinking agent which has been described above must be decreased in order to obtain an appropriate hardness of the constituting member formed from the rubber composition, which may lower the resilience of the golf ball or worsen the durability of the golf ball.

### ((d) Metal Compound)

In the case that the α,β-unsaturated carboxylic acid having 3 to 8 carbon atoms is used as the co-crosslinking agent, (d) a metal compound is preferably further contained. (d) The metal compound is not particularly limited as long as it can neutralize the α,β-unsaturated carboxylic acid having 3 to 8 carbon atoms which is blended as (b) the co-crosslinking agent in the rubber composition. Examples of (d) the metal compound includes a metal hydroxide such as magnesium hydroxide, zinc hydroxide, calcium hydroxide, sodium hydroxide, lithium hydroxide, potassium hydroxide and copper hydroxide; a metal oxide such as magnesium oxide, calcium oxide, zinc oxide and copper oxide; and a metal carbonate such as magnesium carbonate, zinc carbonate, calcium carbonate, sodium carbonate, lithium carbonate and potassium carbonate. (d) The metal compound is preferably a divalent metal compound, more preferably a zinc compound. This is because the divalent metal compound reacts with the α,β-unsaturated carboxylic acid having 3 to 8 carbon atoms, thereby forming a metal crosslinking. Further, use of the zinc compound provides a golf ball with higher resilience. (d) The metal compound may be used solely or as a mixture of at least two of them.

### ((e) Organic Sulfur Compound)

The rubber composition may further contain (e) an organic sulfur compound. Examples of (e) the organic sulfur compound include at least one member selected from the group consisting of thiophenols, thionaphthols, polysulfides, thiurams, thiocarboxylic acids, dithiocarboxylic acids, sulfenamides, dithiocarbamates, thiazoles, and metal salts thereof. In light of obtaining a spherical core having a greater hardness distribution, (e) the organic sulfur compound is preferably an organic sulfur compound having a thiol group (—SH) or a metal salt thereof, and more preferably thiophenols, thionaphthols or metal salts thereof.

Examples of the thiols include thiophenols and thionaphthols. Examples of the thiophenols include thiophenol; thiophenols substituted with a fluoro group, such as 4-fluorothiophenol, 2,5-difluorothiophenol, 2,6-difluorothiophenol, 2,4,5-trifluorothiophenol, 2,4,5,6-tetrafluorothiophenol and pentafluorothiophenol; thiophenols substituted with a chloro group, such as 2-chlorothiophenol, 4-chlorothiophenol, 2,4-dichlorothiophenol, 2,5-dichlorothiophenol, 2,6-dichlorothiophenol, 2,4,5-trichlorothiophenol, 2,4,5,6-tetrachlorothiophenol and pentachlorothiophenol; thiophenols substituted with a bromo group, such as 4-bromothiophenol, 2,5-dibromothiophenol, 2,6-dibromothiophenol, 2,4,5-tribromothiophenol, 2,4,5,6-tetrabromothiophenol and pentabromothiophenol; thiophenols substituted with an iodo group, such as 4-iodothiophenol, 2,5-diiodothiophenol, 2,6-diiodothiophenol, 2,4,5-triiodothiophenol, 2,4,5,6-tetraiodothiophenol and pentaiodothiophenol; and metal salts thereof. As the metal salt, a zinc salt is preferred.

Examples of the thionaphthols (naphthalenethiols) include 2-thionaphthol, 1-thionaphthol, 1-chloro-2-thionaphthol, 2-chloro-1-thionaphthol, 1-bromo-2-thionaphthol, 2-bromo-1-thionaphthol, 1-fluoro-2-thionaphthol, 2-fluoro-1-thionaphthol, 1-cyano-2-thionaphthol, 2-cyano-1-thionaphthol, 1-acetyl-2-thionaphthol, 2-acetyl-1-thionaphthol, and metal salts thereof. Among them, 2-thionaphthol, 1-thionaphthol, and metal salts thereof are preferable. The metal salt is preferably a divalent metal salt, more preferably a zinc salt. Specific examples of the metal salt include zinc salt of 1-thionaphthol and zinc salt of 2-thionaphthol.

The polysulfides are organic sulfur compounds having a polysulfide bond, and examples thereof include disulfides, trisulfides and tetrasulfides. The polysulfides are preferably diphenyl polysulfides.

Examples of the diphenyl polysulfides include diphenyl disulfide; diphenyl disulfides substituted with a halogen group, such as bis(4-fluorophenyl)disulfide, bis(2,5-difluorophenyl)disulfide, bis(2,6-difluorophenyl)disulfide, bis(2,4,5-trifluorophenyl)disulfide, bis(2,4,5,6-tetrafluorophenyl)disulfide, bis(pentafluorophenyl)disulfide, bis(4-chlorophenyl)disulfide, bis(2,5-dichlorophenyl)disulfide, bis(2,6-dichlorophenyl)disulfide, bis(2,4,5-trichlorophenyl)disulfide, bis(2,4,5,6-tetrachlorophenyl)disulfide, bis(pentachlorophenyl)disulfide, bis(4-bromophenyl)disulfide, bis(2,5-dibromophenyl)disulfide, bis(2,6-dibromophenyl)disulfide, bis(2,4,5-tribromophenyl)disulfide, bis(2,4,5,6-tetrabromophenyl)disulfide, bis(pentabromophenyl)disulfide, bis(4-iodophenyl)disulfide, bis(2,5-diiodophenyl)disulfide, bis(2,6-diiodophenyl)disulfide, bis(2,4,5-triiodophenyl)disulfide, bis(2,4,5,6-tetraiodophenyl)disulfide, and bis(pentaiodophenyl)disulfide; and diphenyl disulfides substituted with an alkyl group, such as bis(4-methylphenyl)disulfide, bis(2,4,5-trimethylphenyl)disulfide, bis(pentamethylphenyl)disulfide, bis(4-t-butylphenyl)disulfide, bis(2,4,5-tri-t-butylphenyl)disulfide, and bis(penta-t-butylphenyl)disulfide.

Examples of the thiurams include thiuram monosulfides such as tetramethylthiuram monosulfide; thiuram disulfides such as tetramethylthiuram disulfide, tetraethylthiuram disulfide and tetrabutylthiuram disulfide; and thiuram tetrasulfides such as dipentamethylenethiuram tetrasulfide. Examples of the thiocarboxylic acids include a naphthalene thiocarboxylic acid. Examples of the dithiocarboxylic acids include a naphthalene dithiocarboxylic acid. Examples of the sulfenamides include N-cyclohexyl-2-benzothiazole sulfenamide, N-oxydiethylene-2-benzothiazole sulfenamide, and N-t-butyl-2-benzothiazole sulfenamide.

(e) The organic sulfur compound may be used solely, or at least two of them may be used in combination. (e) The organic sulfur compound is preferably the thiophenols and/or the metal salts thereof, the thionaphthols and/or the metal salts thereof, the diphenyl disulfides and the thiuram disulfides, and more preferably 2,4-dichlorothiophenol, 2,6-difluorothiophenol, 2,6-dichlorothiophenol, 2,6-dibromothiophenol, 2,6-diiodothiophenol, 2,4,5-trichlorothiophenol, pentachlorothiophenol, 1-thionaphthol, 2-thionaphthol, diphenyl disulfide, bis(2,6-difluorophenyl)disulfide, bis(2,6-dichlorophenyl)disulfide, bis(2,6-dibromophenyl)disulfide, bis(2,6-diiodophenyl)disulfide and bis(pentabromophenyl)disulfide.

The amount of (e) the organic sulfur compound is preferably 0.05 part by mass or more, more preferably 0.1 part by mass or more, and is preferably 5.0 parts by mass or less, more preferably 2.0 parts by mass or less, with respect to 100 parts by mass of (a) the base rubber. If the amount of (e) the organic sulfur compound is less than 0.05 part by mass, the effect of adding (e) the organic sulfur compound is not obtained, and thus the resilience of the golf ball may not improve. In addition, if the amount of (e) the organic sulfur compound exceeds 5.0 parts by mass, the obtained golf ball has so great compression deformation amount that the resilience thereof may be lowered.

((f) Carboxylic Acid and/or Salt Thereof)

The rubber composition may further contain (f) a carboxylic acid and/or a salt thereof. If (f) the carboxylic acid and/or the salt thereof is contained, the obtained spherical core has a greater degree of outer-hard and inner-soft structure. Examples of (f) the carboxylic acid and/or the salt thereof include an aliphatic carboxylic acid, an aliphatic carboxylic acid salt, an aromatic carboxylic acid, and an aromatic carboxylic acid salt. (f) The carboxylic acid and/or the salt may be used solely or as a mixture of at least two of them.

The aliphatic carboxylic acid may be a saturated aliphatic carboxylic acid (hereinafter, sometimes referred to as “saturated fatty acid”), or an unsaturated aliphatic carboxylic acid (hereinafter, sometimes referred to as “unsaturated fatty acid”). Further, the aliphatic carboxylic acid may have a branched structure or a cyclic structure. The saturated fatty acid preferably has 1 or more and 30 or less carbon atoms, more preferably 18 or less carbon atoms, and even more preferably 13 or less carbon atoms. The unsaturated fatty acid preferably has 5 or more carbon atoms, more preferably 7 or more carbon atoms, and even more preferably 8 or more carbon atoms, and preferably has 30 or less carbon atoms, more preferably 18 or less carbon atoms, and even more preferably 13 or less carbon atoms. It is noted that (f) the carboxylic acid and/or the salt thereof excludes the α,β-unsaturated carboxylic acid having 3 to 8 carbon atoms and/or the metal salt thereof used as (b) the co-crosslinking agent.

Examples of the aromatic carboxylic acid include a carboxylic acid having a benzene ring in the molecule, and a carboxylic acid having an aromatic heterocycle in the molecule. The aromatic carboxylic acid may be used solely or as a mixture of at least two of them. Examples of the carboxylic acid having a benzene ring include an aromatic carboxylic acid having a carboxyl group directly bonding to a benzene ring, an aromatic-aliphatic carboxylic acid having an aliphatic carboxylic acid bonding to a benzene ring, a polynuclear aromatic carboxylic acid having a carboxyl group directly bonding to a fused benzene rings, and a polynuclear aromatic-aliphatic carboxylic acid having an aliphatic carboxylic acid bonding to a fused benzene rings. Examples of the carboxylic acid having an aromatic heterocycle include a carboxylic acid having a carboxyl group directly bonding to an aromatic heterocycle.

As the aliphatic carboxylic acid salt or aromatic carboxylic acid salt, a salt of the above-mentioned aliphatic carboxylic acid or aromatic carboxylic acid can be used. Examples of the cation component of the salt include a metal ion, an ammonium ion, and an organic cation. Examples of the metal ion include a monovalent metal ion such as sodium, potassium, lithium and silver; a divalent metal ion such as magnesium, calcium, zinc, barium, cadmium, copper, cobalt, nickel and manganese; a trivalent metal ion such as aluminum and iron; and other metal ion such as tin, zirconium and titanium. The cation component may be used solely or as a mixture of at least two of them.

The organic cation is a cation having a carbon chain. The organic cation is not particularly limited, and examples thereof include an organic ammonium ion. Examples of the organic ammonium ion include a primary ammonium ion such as stearyl ammonium ion, hexyl ammonium ion, octyl ammonium ion and 2-ethylhexyl ammonium ion; a secondary ammonium ion such as dodecyl(laury) ammonium ion and octadecyl(stearyl) ammonium ion; a tertiary ammonium ion such as trioctyl ammonium ion; and a quaternary ammonium ion such as dioctyldimethyl ammonium ion and distearyldimethyl ammonium ion. These organic cations may be used solely or as a mixture of at least two of them.

Examples of the aliphatic carboxylic acid and/or the salt thereof include a saturated fatty acid and/or a salt thereof, and an unsaturated fatty acid and/or a salt thereof. The saturated fatty acid and/or the salt thereof is preferred, caprylic acid (octanoic acid), pelargonic acid (nonanoic acid), capric acid (decanoic acid), lauric acid, myristic acid, palmitic acid, stearic acid, behenic acid, and/or potassium salt, magnesium salt, calcium salt, aluminum salt, zinc salt, iron salt, copper salt, nickel salt, cobalt salt of these saturated fatty acids are more preferred. Preferable examples of the unsaturated fatty acid and/or the salt thereof include palmitoleic acid, oleic acid, linoleic acid, arachidonic acid, and/or potassium salt, magnesium salt, calcium salt, aluminum salt, zinc salt, iron salt, copper salt, nickel salt, cobalt salt of these unsaturated fatty acids.

Preferable examples of the aromatic carboxylic acid and/or the salt thereof include benzoic acid, butylbenzoic acid, anisic acid (methoxybenzoic acid), dimethoxybenzoic acid, trimethoxybenzoic acid, dimethylaminobenzoic acid, chlorobenzoic acid, dichlorobenzoic acid, trichlorobenzoic acid, acetoxybenzoic acid, biphenylcarboxylic acid, naphthalenecarboxylic acid, anthracenecarboxylic acid, furancarboxylic acid, thenoic acid, and/or potassium salt, magnesium salt, calcium salt, aluminum salt, zinc salt, iron salt, copper salt, nickel salt, cobalt salt of these aromatic carboxylic acids.

The amount of (f) the carboxylic acid and/or the salt thereof, for example, is preferably 0.5 part by mass or more, more preferably 1.0 part by mass or more, and even more preferably 1.5 parts by mass or more, and is preferably 40 parts by mass or less, more preferably 35 parts by mass or less, and even more preferably 30 parts by mass or less, with respect to 100 parts by mass of (a) the base rubber. If the amount of (f) the carboxylic acid and/or the salt thereof is 0.5 part by mass or more, the spherical core has a greater degree of outer-hard and inner-soft structure, and if the amount of (f) the carboxylic acid and/or the salt thereof is 40 parts by mass or less, lowering in the core hardness is suppressed, and thus the resilience is better.

The rubber composition may further contain additives such as a pigment, a filler for adjusting weight, an antioxidant, a peptizing agent and a softener, where necessary. In addition, the core rubber composition may contain a rubber powder which is obtained by pulverizing a golf ball core or offcuts produced when preparing a core.

Examples of the pigment blended in the core rubber composition include a white pigment, a blue pigment, and a purple pigment. As the white pigment, titanium oxide is preferably used. The type of titanium oxide is not particularly limited, but rutile type is preferably used because of the high opacity thereof. In addition, the amount of titanium oxide is preferably 0.5 part by mass or more, more preferably 2 parts by mass or more, and is preferably 8 parts by mass or less, more preferably 5 parts by mass or less, with respect to 100 parts by mass of (a) the base rubber.

It is also preferred that the core rubber composition contains both a white pigment and a blue pigment. The blue pigment is blended in order to cause white color to be vivid, and examples thereof include ultramarine blue, cobalt blue, and phthalocyanine blue. In addition, examples of the purple pigment include anthraquinone violet, dioxazine violet, and methyl violet.

The filler blended in the rubber composition is mainly used as a weight adjusting agent for adjusting the weight of the golf ball obtained as a final product, and may be blended where necessary. Examples of the filler include an inorganic filler such as zinc oxide, barium sulfate, calcium carbonate, magnesium oxide, tungsten powder, and molybdenum powder.

The amount of the antioxidant is preferably 0.1 part by mass or more and 1 part by mass or less with respect to 100 parts by mass of (a) the base rubber. In addition, the amount of the peptizing agent is preferably 0.1 part by mass or more and 5 parts by mass or less with respect to 100 parts by mass of (a) the base rubber.

### [Preparation of Compound Represented by the Formula (1)]

The compound represented by the formula (1) is obtained by contacting a carboxylic acid and a metal oxide. Specific examples of the method of obtaining the compound represented by the formula (1) include a method of stirring a metal oxide and at least a first carboxylic acid and a second carboxylic acid in a solvent.

Examples of the metal oxide include an alkaline earth metal oxide such as calcium oxide, strontium oxide and barium oxide; a transition metal oxide such as scandium oxide, titanium oxide, vanadium oxide, chromium oxide, manganese oxide, iron oxide, cobalt oxide, nickel oxide, copper oxide, yttrium oxide, zirconium oxide, niobium oxide, molybdenum oxide, technetium oxide, ruthenium oxide, rhodium oxide, palladium oxide, silver oxide, hafnium oxide, tantalum oxide, tungsten oxide, rhenium oxide, osmium oxide, iridium oxide, platinum oxide and gold oxide; and a base metal oxide such as beryllium oxide, magnesium oxide, aluminum oxide, zinc oxide, gallium oxide, cadmium oxide, indium oxide, tin oxide, thallium oxide, lead oxide, bismuth oxide and polonium oxide. These metal oxides may be used solely, or a mixture of at least two of them may be used. Among them, as the metal oxide, the divalent metal oxide is preferable, and beryllium oxide, magnesium oxide, calcium oxide, zinc oxide, barium oxide, cadmium oxide or lead oxide is more preferable.

Examples of the carboxylic acid include a saturated fatty acid having 2 to 30 carbon atoms, an unsaturated fatty acid having 3 to 30 carbon atoms, and an aromatic carboxylic acid having 7 to 30 carbon atoms.

Examples of the saturated fatty acid include ethanoic acid, propanoic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, and nonadecanoic acid.

Examples of the unsaturated fatty acid include an unsaturated fatty acid having a carbon-carbon double bond and an unsaturated fatty acid having a carbon-carbon triple bond. Examples of the unsaturated fatty acid having a carbon-carbon double bond include an unsaturated fatty acid having a double bond at an α-position carbon (α,β-unsaturated carboxylic acid) such as propenoic acid (acrylic acid), 2-methylprop-2-enoic acid (methacrylic acid) and 2-butenoic acid; and an unsaturated fatty acid having no double bond at an α-position carbon such as 3-butenoic acid, 4-pentenoic acid, 5-hexenoic acid, 6-heptenoic acid, 7-octenoic acid, 8-nonenoic acid, 9-decenoic acid, 10-undecenoic acid, 11-dodecenoic acid, 12-tridecenoic acid, 9-tetradecenoic acid, 13-tetradecenoic acid, 14-pentadecenoic acid, 9-hexadecenoic acid, 15-hexadecenoic acid, 16-heptadecenoic acid, 9-octadecenoic acid, 11-octadecenoic acid, 17-octadecenoic acid, 18-nonadecenoic acid, 9-eicosenoic acid, 11-eicosenoic acid, and 13-docosenoic acid. Examples of the unsaturated fatty acid having a carbon-carbon triple bond include an unsaturated fatty acid having a carbon-carbon triple bond at an α-position carbon such as propiolic acid and 2-butynoic acid; and an unsaturated fatty acid having no carbon-carbon triple bond at an α-position carbon such as 3-butynoic acid, 4-pentynoic acid, 5-hexynoic acid, 6-heptynoic acid, 7-octynoic acid, 8-nonynoic acid, 9-decynoic acid, 10-undecynoic acid, 11-doecynoic acid, 12-tridecynoic acid, 9-tetradecynoic acid, 13-tetradecynoic acid, 14-pentadecynoic acid, 9-hexadecynoic acid, 15-hexadecynoic acid, 16-heptadecynoic acid, 9-octadecynoic acid, 11-octadecynoic acid, 17-octadecynoic acid, and 18-nonadecynoic acid.

Examples of the aromatic carboxylic acid include benzoic acid, butylbenzoic acid, anisic acid (methoxybenzoic acid), dimethoxybenzoic acid, trimethoxybenzoic acid, dimethylaminobenzoic acid, chlorobenzoic acid, dichlorobenzoic acid, trichlorobenzoic acid, acetoxybenzoic acid, biphenyl carboxylic acid, naphthalenecarboxylic acid, and anthracenecarboxylic acid.

The first carboxylic acid is preferably an unsaturated fatty acid, more preferably an unsaturated fatty acid having a double bond at an α-position carbon or an unsaturated fatty acid having a triple bond at an α-position carbon, and most preferably propenoic acid or 2-methylprop-2-enoic acid.

The second carboxylic acid is preferably an unsaturated fatty acid, more preferably an unsaturated fatty acid having no double bond or triple bond at an α-position carbon, and most preferably 9-tetradecenoic acid, 9-hexadecenoic acid, 9-octadecenoic acid and 11-octadecenoic acid.

The amounts of the first carboxylic acid and the second carboxylic acid can be suitably adjusted in accordance with the desired chemical structure of the fatty acid metal salt. It is noted that, when a product obtained by multiplying the mole number of the metal ion in the metal oxide by the valence of that metal ion (when multiple metal ions exist, a total of products obtained by multiplying the mole number of each metal ion by the valence of that metal ion) is adopted as X, the mole number of the carboxyl group in the first carboxylic acid is adopted as Y₁, and the mole number of the carboxyl group in the second carboxylic acid is adopted as Y₂, the ratio ((Y₁+Y₂)/X) is preferably 0 or more and 1.0 or less.

The molar ratio (second carboxylic acid/first carboxylic acid) of the second carboxylic acid to the first carboxylic acid can be suitably adjusted, and for example, is preferably 0.01 or more, more preferably 0.02 or more, and even more preferably 0.04 or more, and is preferably 0.67 or less, more preferably 0.43 or less, and even more preferably 0.33 or less.

Examples of the solvent include toluene and xylene. The amount of the solvent is preferably 0.01 part by mass or more, more preferably 0.1 part by mass or more, and even more preferably 1 part by mass or more, and is preferably 100 parts by mass or less, more preferably 50 parts by mass or less, even more preferably 10 parts by mass or less, and most preferably 3 parts by mass or less, with respect to 100 parts by mass of a total amount of the metal oxide and the carboxylic acid.

The liquid temperature when mixing the metal oxide and the carboxylic acid is preferably 10° C. or more, more preferably 15° C. or more, and is preferably 70° C. or less, more preferably 50° C. or less. The stirring time when mixing the metal oxide and the carboxylic acid can be suitably adjusted.

In the case that a third carboxylic acid is further used as the carboxylic acid in addition to the first carboxylic acid and the second carboxylic acid, the amounts of the first carboxylic acid, the second carboxylic acid and the third carboxylic acid can be suitably adjusted in accordance with the desired chemical structure of the fatty acid metal salt. It is noted that, when a product obtained by multiplying the mole number of the metal ion in the metal oxide by the valence of that metal ion (when multiple metal ions exist, a total of products obtained by multiplying the mole number of each metal ion by the valence of that metal ion) is adopted as X, the mole number of the carboxyl group in the first carboxylic acid is adopted as Ys, the mole number of the carboxyl group in the second carboxylic acid is adopted as Y₂, and the mole number of the carboxyl group in the third carboxylic acid is adopted as Y₃, the ratio ((Y₁+Y₂+Y₃)/X) is preferably 0 or more and 1.0 or less.

### [Preparation of Rubber Composition]

The rubber composition used in the present invention may be obtained by mixing and kneading (a) the base rubber, (b) the co-crosslinking agent and (c) the crosslinking initiator, as well as other additives where necessary. The kneading may be carried out, without any limitation, for example, using a conventional kneading machine such as a kneading roll, a banbury mixer and a kneader.

The spherical core of the golf ball according to the present invention may be obtained by molding the kneaded rubber composition in a mold. The temperature for molding the spherical core is preferably 100° C. or more, more preferably 110° C. or more, and even more preferably 120° C. or more, and is preferably 170° C. or less. If the molding temperature exceeds 170° C., the surface hardness of the core tends to be lowered. In addition, the molding pressure preferably ranges from 2.9 MPa to 11.8 MPa, and the molding time preferably ranges from 10 minutes to 60 minutes.

The hardness difference (Hs−Ho) between the surface hardness Hs and the center hardness Ho of the spherical core is preferably 0 or more, more preferably 10 or more, even more preferably 15 or more, and most preferably 17 or more, and is preferably 60 or less, more preferably 55 or less, and even more preferably 50 or less in Shore C hardness. If the hardness difference is large, the golf ball showing a higher launch angle and a lower spin rate, thereby travelling a greater distance can be obtained.

The center hardness Ho of the spherical core is preferably 30 or more, more preferably 35 or more, and even more preferably 40 or more in Shore C hardness. If the spherical core has a center hardness Ho of 30 or more in Shore C hardness, the spherical core does not become excessively soft, and thus has better resilience. In addition, the center hardness Ho of the spherical core is preferably 70 or less, more preferably 65 or less, and even more preferably 60 or less in Shore C hardness. If the spherical core has a center hardness Ho of 70 or less in Shore C hardness, the spherical core does not become excessively hard, and thus has better shot feeling.

The surface hardness Hs of the spherical core is preferably 65 or more, more preferably 70 or more, and even more preferably 72 or more, and is preferably 100 or less, more preferably 95 or less, and even more preferably 90 or less in Shore C hardness. If the spherical core has a surface hardness of 65 or more in Shore C hardness, the spherical core does not become excessively soft, and thus has better resilience. In addition, if the spherical core has a surface hardness of 100 or less in Shore C hardness, the spherical core does not become excessively hard, and thus has better shot feeling.

The diameter of the spherical core is preferably 34.8 mm or more, more preferably 36.8 mm or more, and even more preferably 38.8 mm or more, and is preferably 42.2 mm or less, more preferably 41.8 mm or less, even more preferably 41.2 mm or less, and most preferably 40.8 mm or less. If the spherical core has a diameter of 34.8 mm or more, the thickness of the cover does not become excessively thick, and thus the resilience of the golf ball is better. On the other hand, if the spherical core has a diameter of 42.2 mm or less, the cover does not become excessively thin, and thus the cover functions better.

When the spherical core has a diameter in a range from 34.8 mm to 42.2 mm, the compression deformation amount (shrinking amount along the compression direction) of the spherical core when applying a load from an initial load of 98 N to a final load of 1275 N to the spherical core is preferably 2.0 mm or more, more preferably 2.8 mm or more, and is preferably 6.0 mm or less, more preferably 5.0 mm or less. If the compression deformation amount is 2.0 mm or more, the shot feeling is better, and if the compression deformation amount is 6.0 mm or less, the resilience is better.

### [Cover]

The cover of the golf ball is formed from a cover composition containing a resin component. Examples of the resin component include an ionomer resin, a thermoplastic polyurethane elastomer having a trade name of “Elastollan (registered trademark)” available from BASF Japan Ltd., a thermoplastic polyamide elastomer having a trade name of “Pebax (registered trademark)” available from Arkema K. K., a thermoplastic polyester elastomer having a trade name of “Hytrel (registered trademark)” available from Du Pont-Toray Co., Ltd., and a thermoplastic styrene elastomer having a trade name of “Rabalon (registered trademark)” available from Mitsubishi Chemical Corporation.

The cover composition for forming the cover of the golf ball according to the present invention preferably contains a thermoplastic polyurethane elastomer or an ionomer resin as the resin component. It is also preferred that when the ionomer resin is used, a thermoplastic styrene elastomer is used in combination. The amount of the polyurethane or ionomer resin in the resin component of the cover composition is preferably 50 mass % or more, more preferably 60 mass % or more, and even more preferably 70 mass % or more.

In addition to the above mentioned resin component, the cover composition may further contain a pigment component such as a white pigment (e.g. titanium oxide), a blue pigment and a red pigment, a weight adjusting agent such as zinc oxide, calcium carbonate and barium sulfate, a dispersant, an antioxidant, an ultraviolet absorber, a light stabilizer, a fluorescent material or fluorescent brightener, or the like, unless they impair the performance of the cover.

The amount of the white pigment (e.g. titanium oxide) is preferably 0.5 part by mass or more, more preferably 1 part by mass or more, and is preferably 10 parts by mass or less, more preferably 8 parts by mass or less, with respect to 100 parts by mass of the resin component constituting the cover. If the amount of the white pigment is 0.5 part by mass or more, it is possible to impart the opacity to the cover. In addition, if the amount of the white pigment exceeds 10 parts by mass, the durability of the obtained cover may deteriorate.

The slab hardness of the cover composition is preferably set in accordance with the desired performance of the golf ball. For example, in case of a so-called distance golf ball which focuses on a flight distance, the cover composition preferably has a slab hardness of 50 or more, more preferably 55 or more, and preferably has a slab hardness of 80 or less, more preferably 70 or less in Shore D hardness. If the cover composition has a slab hardness of 50 or more, the obtained golf ball has a high launch angle and a low spin rate on driver shots and iron shots, and thus travels a great distance. In addition, if the cover composition has a slab hardness of 80 or less, the obtained golf ball is excellent in durability. Further, in case of a so-called spin golf ball which focuses on controllability, the cover composition preferably has a slab hardness of less than 50, and preferably has a slab hardness of 20 or more, more preferably 25 or more in Shore D hardness. If the cover composition has a slab hardness of less than 50, the flight distance on driver shots can be increased by the core of the present invention, as well as the obtained golf ball readily stops on the green due to the high spin rate on approach shots. In addition, if the cover composition has a slab hardness of 20 or more, the abrasion resistance is enhanced. In case that the cover has a plurality of layers, the slab hardness of the cover composition constituting each layer may be identical to or different from each other, as long as the slab hardness falls within the above range.

Examples of the method for molding the cover of the golf ball according to the present invention include a method which comprises molding the cover composition into a hollow shell, covering the core with a plurality of the hollow shells, and subjecting the core with a plurality of the hollow shells to compression molding (preferably a method which comprises molding the cover composition into a hollow half shell, covering the core with two of the hollow half shells, and subjecting the core with two of the hollow half shells to compression molding); and a method which comprises injection molding the cover composition directly onto the core.

The concave portions called “dimple” are usually formed on the surface of the cover. The total number of the dimples is preferably 200 or more and 500 or less. If the total number of the dimples is less than 200, the dimple effect is hardly obtained. In addition, if the total number of the dimples exceeds 500, the dimple effect is hardly obtained because the size of the respective dimple is small. The shape (shape in a plan view) of the dimples formed on the cover includes, but is not limited to, a circle; a polygonal shape such as a roughly triangular shape, a roughly quadrangular shape, a roughly pentagonal shape and a roughly hexagonal shape; and other irregular shape. These shapes may be employed solely, or at least two of them may be employed in combination.

The thickness of the cover is preferably 4.0 mm or less, more preferably 3.0 mm or less, and even more preferably 2.0 mm or less. If the thickness of the cover is 4.0 mm or less, the obtained golf ball has better resilience or shot feeling. The thickness of the cover is preferably 0.3 mm or more, more preferably 0.5 mm or more, even more preferably 0.8 mm or more, and most preferably 1.0 mm or more. If the thickness of the cover is less than 0.3 mm, the durability or wear resistance of the cover may be lowered. In case that the cover has a plurality of layers, the total thickness of a plurality of cover layers preferably falls within the above range. The golf ball body having the cover formed thereon is ejected from the mold, and is preferably subjected to surface treatments such as deburring, cleaning and sandblast where necessary. In addition, if desired, a paint film or a mark may be formed.

The golf ball according to the present invention preferably has a diameter in a range from 40 mm to 45 mm. In light of satisfying the regulation of US Golf Association (USGA), the diameter is most preferably 42.67 mm or more. In light of prevention of air resistance, the diameter is more preferably 44 mm or less, and most preferably 42.80 mm or less. In addition, the golf ball preferably has a mass of 40 g or more and 50 g or less. In light of obtaining greater inertia, the mass is more preferably 44 g or more, and most preferably 45.00 g or more. In light of satisfying the regulation of USGA, the mass is most preferably 45.93 g or less.

When the golf ball according to the present invention has a diameter in a range from 40 mm to 45 mm, the compression deformation amount (shrinking amount along the compression direction) of the golf ball when applying a load from an initial load of 98 N to a final load of 1275 N to the golf ball is preferably 2.0 mm or more, more preferably 2.4 mm or more, even more preferably 2.5 mm or more, and most preferably 2.8 mm or more, and is preferably 4.0 mm or less, more preferably 3.8 mm or less, and even more preferably 3.6 mm or less. If the compression deformation amount is 2.0 mm or more, the golf ball does not become excessively hard, and thus has better shot feeling. On the other hand, if the compression deformation amount is 4.0 mm or less, the golf ball has better resilience.

The construction of the golf ball according to the present invention is not particularly limited, as long as the golf ball comprises a spherical core and one or more cover layers covering the spherical core. The spherical core preferably has a single-layered construction. Unlike the multi-layered spherical core, the single-layered spherical core does not have an energy loss at the interface of the multi-layered construction when being hit, and thus has better resilience. In addition, the cover has one or more layers, and may have a single-layered construction or a multi-layered construction composed of at least two layers. Examples of the golf ball according to the present invention include a two-piece golf ball composed of a spherical core and a single-layered cover disposed around the spherical core; a multi-piece golf ball (including a three-piece golf ball) comprising a spherical core and two or more cover layers disposed around the spherical core: and a wound golf ball comprising a spherical core, a rubber thread layer disposed around the spherical core, and a cover disposed around the rubber thread layer. The present invention can be suitably applied to any one of the above golf balls.

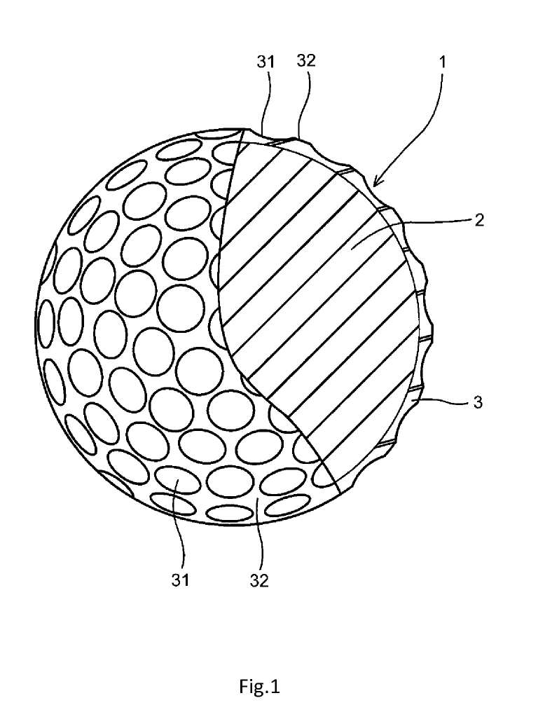

FIG. 1 is a partially cutaway cross-sectional view showing a golf ball 1 according to an embodiment of the present invention. The golf ball 1 comprises a spherical core 2 and a cover 3 covering the spherical core 2. A plurality of dimples 31 are formed on the surface of the cover 3. Other portion than the dimples 31 on the surface of the cover 3 is lands 32. The golf ball 1 further comprises a paint layer and a mark layer outside the cover 3, but these layers are not depicted.

### EXAMPLES

Next, the present invention will be described in detail by way of examples. However, the present invention is not limited to the examples described below. Various changes and modifications without departing from the spirit of the present invention are all included in the scope of the present invention.

### [Evaluation Methods]

### (1) Compression Deformation Amount (mm)

The deformation amount of the core along the compression direction (shrinking amount of the core along the compression direction), when applying a load from an initial load of 98 N to a final load of 1275 N to the core, was measured.

### (2) Coefficient of Restitution

A metal cylindrical object with a mass of 198.4 g was allowed to collide with each core at a speed of 40 m/sec, and the speeds of the cylindrical object and the core before and after the collision were measured. Based on these speeds and the mass of each object, the coefficient of restitution of each core was calculated. The measurement was conducted using twelve samples for each core, and the average value thereof was adopted as the coefficient of restitution for that core.

### [Preparation of Fatty Acid Metal Salt]

### (1) Fatty Acid Metal Salt No. 1

Into a jacket type vertical mixer with a volume of 10 L, 580 g (7.12 mol) of zinc oxide and 1000 ml of toluene were charged. While the resultant liquid was being suspended under stirring, 1000 g (13.9 mol) of acrylic acid and 206 g (0.73 mol) of oleic acid were added dropwise therein for 180 minutes, and the resultant mixture was reacted at 40° C. for 240 minutes. After the reaction, the solvent was removed to obtain the fatty acid metal salt No. 1.

### (2) Fatty Acid Metal Salt No. 2

Into a jacket type vertical mixer with a volume of 10 L, 580 g (7.12 mol) of zinc oxide and 1000 ml of toluene were charged. While the resultant liquid was being suspended under stirring, 1000 g (13.9 mol) of acrylic acid and 435 g (1.54 mol) of oleic acid were added dropwise therein for 180 minutes, and the resultant mixture was reacted at 40° C. for 240 minutes. After the reaction, the solvent was removed to obtain the fatty acid metal salt No. 2.

### [Production of Golf Ball]

### (1) Production of Core

The rubber compositions having the formulations shown in Table 1 were kneaded with a kneading roll, and heat pressed at 170° C. for 20 minutes in upper and lower molds, each having a hemispherical cavity, to produce spherical cores having a diameter of 39.8 mm.

TABLE 1

| | | | Golf ball No. | | | | | |
|---|---|---|---|---|---|---|---|---|
| | | | A | B | C | D | E | F |
| Core formulation | (a) | BR | 100 | 100 | 100 | 100 | 100 | 100 |
| (parts by mass) | (b) | ZDA | 27.5 | 29.5 | — | — | — | — |
| | | Fatty acid metal salt No. 1 | — | — | 27.5 | 29.5 | — | — |
| | | Fatty acid metal salt No. 2 | — | — | — | — | 30 | 32 |
| | (c) | Dicumyl peroxide | 0.9 | 0.9 | 0.9 | 0.9 | 0.9 | 0.9 |
| | (d) | Zinc oxide | 12 | 12 | 12 | 12 | 12 | 12 |
| | (e) | Thionaphthol | 0.1 | 0.1 | 0.1 | 0.1 | 0.1 | 0.1 |
| | | PBDS | 0.4 | 0.4 | 0.4 | 0.4 | 0.4 | 0.4 |
| | (f) | Benzoic acid | 2 | 2 | 2 | 2 | 2 | 2 |

| | | | | | | | |
|---|---|---|---|---|---|---|---|
| | Filler | 2 | 2 | 2 | 2 | 2 | 2 |
| | Rubber powder | 1 | 1 | 1 | 1 | 1 | 1 |
| Core evaluation | Compression deformation amount (mm) | 5.05 | 4.73 | 4.98 | 4.62 | 5.10 | 4.86 |
| | Coefficient of restitution (%) | 0.7527 | 0.7616 | 0.7616 | 0.7680 | 0.7560 | 0.7602 |

The materials used in Table 1 are shown as follows.

BR: “BR730” (high-cis polybutadiene rubber (amount of cis-1,4 bond=96 mass %, amount of 1,2-vinyl bond=1.3 mass %, Moony viscosity (ML₁₊₄ (100° C.)=55, molecular weight distribution (Mw/Mn)=3)) available from JSR Corporation

ZDA: “ZN-DA90S” (zinc acrylate (a product containing zinc stearate in an amount of 10 mass %)) available from Nisshoku Techno Fine Chemical Co., Ltd.

Dicumyl peroxide: “Percumyl (register trademark) D” available from NOF Corporation

Zinc oxide: “Ginrei R” available from Toho Zinc Co., Ltd.

Thionaphthol: 2-thionaphthol available from Tokyo Chemical Industry Co., Ltd.

PBDS: bis(pentabromophenyl) disulfide available from Kawaguchi Chemical Industry Co., Ltd.

Benzoic acid: (purity of at least 98%) available from Tokyo Chemical Industry Co., Ltd.

Filler: “Barium Sulfate BD” available from Sakai Chemical Industry Co., Ltd.

Rubber powder: obtained by pulverizing a golf ball core formed from a rubber composition

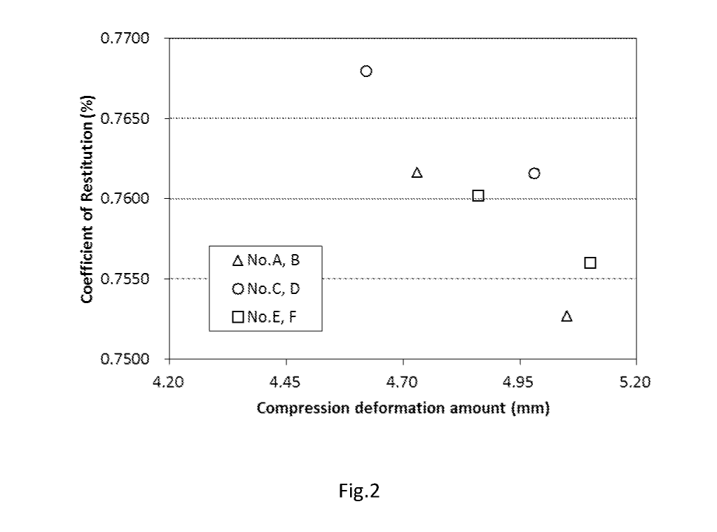

Evaluation results of each core are shown in Table 1. In addition, relationships of the compression deformation amount (mm) and the coefficient of restitution (%) of each core are shown in FIG. 2. It is apparent from FIG. 2 that both the cores (No. C, D) using the fatty acid metal salt No. 1 as (b) the co-crosslinking agent and the cores (No. E. F) using the fatty acid metal salt No. 2 as (b) the co-crosslinking agent have more excellent resilience performance than the cores No. A and No. B.

This application is based on Japanese Patent Application No. 2016-253566 filed on Dec. 27, 2016, the content of which is hereby incorporated by reference.

1. A golf ball comprising a spherical core and at least one cover layer covering the spherical core, wherein the spherical core is formed from a rubber composition containing (a) a base rubber, (b) a co-crosslinking agent and (c) a crosslinking initiator, and (b) the co-crosslinking agent contains a compound represented by a formula (1):
(R¹OCO)M(COOR²)ₘ (1)
in the formula (1), M represents a metal atom, and m represents 1 or 2; when m is 1, R¹ and R² are different from each other and represent an alkenyl group having 2 to 30 carbon atoms or an alkynyl group having 2 to 30 carbon atoms; when m is 2, R¹ represents an alkenyl group having 2 to 30 carbon atoms, an alkynyl group having 2 to 30 carbon atoms, an alkyl group having 1 to 30 carbon atoms or an aryl group having 6 to 30 carbon atoms, and two of R² are identical to or different from each other and represent an alkenyl group having 2 to 30 carbon atoms or an alkynyl group having 2 to 30 carbon atoms; and when m is 2, a compound in which R¹ and two of R² are all identical to each other is excluded.

2. The golf ball according to claim 1, wherein in the compound represented by the formula (1), the metal atom (M) is at least one metal atom selected from the group consisting of zinc, calcium, magnesium and aluminum.

3. The golf ball according to claim 1, wherein in the compound represented by the formula (1), R² is an alkenyl group having 2 to 30 carbon atoms and a carbon-carbon double bond at a carbon atom bonding to the carbonyl group of the compound represented by the formula (1).

4. The golf ball according to claim 1, wherein in the compound represented by the formula (1), R¹ is an alkenyl group having 2 to 30 carbon atoms and no carbon-carbon double bond at a carbon atom bonding to the carbonyl group of the compound represented by the formula (1).

5. The golf ball according to claim 1, wherein in the compound represented by the formula (1), R¹ has more carbon atoms than R².

6. The golf ball according to claim 1, wherein the compound represented by the formula (1) is a compound represented by a formula (2): 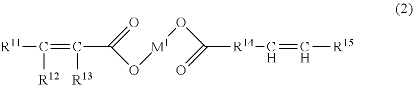
in the formula (2), M¹ represents a metal atom, R¹¹, R¹² and R¹³ are identical to or different from each other and represent a hydrogen atom or an alkyl group having 1 to 28 carbon atoms, R¹⁴ represents an alkylene group having 1 to 28 carbon atoms, and R¹⁵ represents a hydrogen atom or an alkyl group having 1 to 27 carbon atoms.

7. The golf ball according to claim 6, wherein M¹ is at least one member selected from the group consisting of beryllium, magnesium, calcium, zinc, barium, cadmium, lead and aluminum.

8. The golf ball according to claim 6, wherein R¹¹ to R¹³ are a hydrogen atom; or R¹¹ and R¹² are a hydrogen atom and R¹³ is a methyl group.

9. The golf ball according to claim 1, wherein the compound represented by the formula (1) is a compound represented by a formula (3): 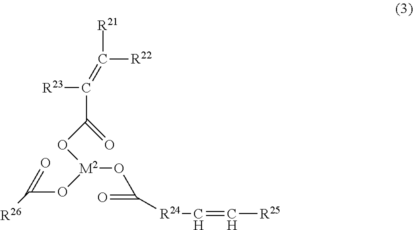
in the formula (3), M² represents a metal atom, R²¹, R²² and R²³ are identical to or different from each other and represent a hydrogen atom or an alkyl group having 1 to 28 carbon atoms, R²⁴ represents an alkylene group having 1 to 28 carbon atoms, R²⁵ represents a hydrogen atom or an alkyl group having 1 to 27 carbon atoms, R²⁶ represents an alkenyl group having 2 to 30 carbon atoms, an alkynyl group having 2 to 30 carbon atoms, an alkyl group having 1 to 30 carbon atoms, or an aryl group having 6 to 30 carbon atoms.

10. The golf ball according to claim 9, wherein M² is at least one member selected from the group consisting of beryllium, magnesium, calcium, zinc, barium, cadmium, lead and aluminum.

11. The golf ball according to claim 9, wherein R²¹ to R²³ are a hydrogen atom; or R²¹ and R²² are a hydrogen atom and R²³ is a methyl group.

12. The golf ball according to claim 1, wherein (b) the co-crosslinking agent further contains another co-crosslinking agent than the compound represented by the formula (1).

13. The golf ball according to claim 12, wherein the other co-crosslinking agent is an α,β-unsaturated carboxylic acid having 3 to 8 carbon atoms and/or a metal salt thereof.

14. The golf ball according to claim 12, wherein (b) the co-crosslinking agent contains the compound represented by the formula (1) in an amount of ranging from 3 mass % to 40 mass %.

15. The golf ball according to claim 1, wherein the rubber composition contains (b) the co-crosslinking agent in an amount of ranging from 10 parts by mass to 50 parts by mass with respect to 100 parts by mass of (a) the base rubber.

16. The golf ball according to claim 1, wherein the rubber composition further contains (d) a metal compound, (e) an organic sulfur compound, and/or (f) a carboxylic acid and/or a salt thereof.
